(19) United States
(12) Patent Application Publication
(10) Pub. No.: US 2005/0159166 A1
(43) Pub. Date: Jul. 21, 2005

(54) Quality of service controlled link adaptation

(75) Inventors: Tomas Jonsson, Lulea (SE); Ylva Timner, Lulea (SE); Peter de Bruin, Gammelstad (SE); Johan Axnas, Solna (SE)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson (publ), Stockholm (SE)

(21) Appl. No.: 10/760,545

(22) Filed: Jan. 21, 2004

(51) Int. Cl. H04Q 7/20

(52) U.S. Cl. 455/452.2

(57) ABSTRACT

A quality of service profile for a mobile communication subscriber unit is determined and includes one or more mobile-specific desired quality of service parameters. Actual values for the service parameter(s) is(are) determined and fed back to a link quality controller to determine whether they are in an acceptable range or relationship with corresponding actual quality of service parameter values. A modulation and/or coding scheme for transmitting the information over the radio link is selected or adjusted based on whether the desired and actual quality of service parameters are in an acceptable range or acceptable relationship. A combined “desired” quality of service parameter using the first and second quality of service parameters (or more if desired) may be determined. A combined “actual” quality of service parameter using first and second actual quality service parameter values is determined. Those combined desired and actual quality of service parameters are compared to determine whether they are in an acceptable range or relationship. The modulation or coding scheme (or both) is (are) selected or adjusted based thereon.

### TECHNICAL FIELD

The present invention relates to wireless data communication systems, and more particularly, to adapting parameters related to the wireless link when communicating data.

### BACKGROUND AND SUMMARY

Enhanced general packet radio service (EGPRS) attempts to increase data capacity and throughput over the radio interface. EGPRS employs a functionality, often referred to as “link quality control” (LQC), to more efficiently transmit information in view of a current condition on the radio link. Current EGPRS link quality control employs two different and independent methods that may be combined to achieve desired LQC behavior. The first is link adaptation (LA), which efficiently maps one of plural modulation and coding schemes (MCSs) to the current radio link quality. The second is incremental redundancy (IR), which efficiently utilizes incorrectly received data blocks to increase the decoding probability.

Each Modulation and Coding Scheme (MCS) is a given combination of modulation and channel coding. Different MCSs achieve different combinations of robustness and maximum achievable bit rate so that different radio quality levels can be efficiently utilized. In link adaptation, a particular MCS may be selected for each data block transmitted over the radio interface. EGPRS offers two modulations schemes: Gaussian, minimum-shift keying (GMSK) and 8-ary phase shift keying (8-PSK). 8-PSK modulation has three times the bit-per-symbol density of GMSK, resulting in potentially higher throughput over the radio link. One of four different coding schemes may be selected for GMSK transmission, resulting in modulation and coding schemes MCS-1 through MCS-4, and one of five different coding schemes may be selected for 8-PSK transmission, resulting in modulation and coding schemes MCS-5 through MCS-9. Each MCS gives a different level of protection against symbol errors. Within each modulation, a lower number MCS corresponds to a lower code rate (also referred to as “stronger” or more robust). A coding scheme is stronger or more robust than another if it is capable of correcting more errors per data block. For example, MCS-1 is the strongest/most robust of the four GMSK MCSs, and MCS-4 is the weakest/least robust of them. But MCS-1 offers the lowest nominal throughput (throughput under perfect radio conditions) of the four, and MCS-4 offers the highest throughput. Similar relations hold among the 8-PSK MCSs.

Comparing MCSs belonging to different modulations, it cannot always be determined which is more robust, as this determination depends to some extent on the radio environment. Often, however, the GMSK MCS will appear more robust because of a three times lower bits-per-symbol density, which gives three times as much energy per modulated bit. It is generally the case that the higher the number of the MCS, the higher the nominal throughput.

EGPRS networks thus permit selection of one of nine modulation and coding schemes, MCS-1 to MCS-9, each with different robustness and nominal throughput. As the number of the MCS increases, so does its nominal throughput with tradeoffs in robustness. Less robustness means increased likelihood of errors, increased retransmissions of blocks containing errors, increased delay, and reduced link throughput.

Incremental redundancy (IR) provides efficient utilization of incorrectly/erroneously-received data. Retransmitted blocks carry additional, redundant bits to help the receiver correctly decode the block. Because these additional bits are transmitted only when needed, the impact on throughput over the radio link is controlled. Fields in the header of the block identify the sequence number of the block and the redundancy scheme applied at the transmitter. The receiver can then jointly decode multiple versions of the same block using soft combining to improve receiver performance.

Link adaptation and incremental redundancy can efficiently be combined in the following way. For every radio block, link adaptation may be used to select the most suitable MCS for the first transmission, and if the transmission fails, incremental redundancy is used to enable combination of received radio blocks until the full block is correctly decoded.

A link adaptation algorithm attempts to select the best modulation and coding scheme to use in view of the current radio link conditions. The conventional objective of link adaptation algorithms is to maximize link throughput. But a throughput maximization approach to link adaptation does not take into account particular quality of service requirements, (see e.g., 3GPP TS 23.107), for individual user communications. For example, some quality of service requirements include higher bit rates, while others may have stronger demands for shorter delay. In fact, most quality of service requirements include multiple components, e.g., a particular delay and a particular bit rate.

A problem with conventional link quality control realizations is that the MCSs are chosen as a function of radio conditions, and not as a function of the desired QoS requirements. This may mean that services with different quality of service profiles must use the same link quality control strategy. One unfortunate result may be that a delay-sensitive service does not get the performance requested in its QoS profile, since the LQC algorithm is optimized for a high throughput over a link or channel, which is typically shared by multiple users. The LQC process does not consider QoS attributes actually desired by specific users. Maximizing link throughout over a link shared by multiple users does not ensure that the QoS bit rate requirement for a single user is met. Also, current LQC algorithms do not use closed-loop feedback, which means less precise control. Another problem with conventional link adaptation control algorithms is that link quality measurements and estimates often prove to be unreliable and inaccurate. Also, there is a delay between performing link quality measurements and reporting them to the link adaptation algorithm. The larger this time lag, the harder it is to adapt to rapidly changing radio conditions.

The present invention solves these problems by specifically addressing quality of service parameters in link quality control. A quality of service profile determined for a communication involving the mobile subscriber unit includes one or more desired quality of service parameters. Actual values for the quality of service parameters are determined and fed back to a link quality controller to determine whether each QoS parameter is in an acceptable range or relationship relative to the corresponding actual quality of service parameter value. A modulation and coding scheme (MCS) for transmitting the information over the radio link is selected or adjusted based on whether the desired and actual quality of service parameters are within the acceptable range or relationship. Examples of the quality of service parameters include bit rate, (guaranteed, maximum, minimum, etc.), transmission delay (maximum, average, etc.), availability (low down time), connection set up time, bandwidth, packet loss, jitter, etc. The MCS may be selected or adjusted for transmitting information over the radio link from the radio network to the wireless subscriber unit or from the wireless subscriber unit to the radio network (or both).

Another inventive aspect is the use of a combined quality of service measure or parameter in the link adaptation control. A combined “desired” quality of service parameter is determined using two or more (e.g, first and second) “desired” quality of service parameters from the quality of service profile associated with the mobile communication. A combined “actual” quality of service parameter using detected “actual” quality service parameter values is determined. The combined desired and actual quality of service parameters are compared to determine whether they are in an acceptable range or relationship. The modulation and/or coding scheme is (are) selected or adjusted based on whether the combined desired and actual quality of service parameters are within that acceptable range or relationship. Using a combined quality of service parameter facilitates feedback and simplifies the link adaptation procedure.

In a preferred, non-limiting, example embodiment, first and second quality of service parameters correspond to a guaranteed bit rate and a maximum transfer delay. The combined quality of service parameter is formulated using the guaranteed bit rate and the maximum transfer delay for the mobile communication. Preferably, the MCS selection procedure also tries to achieve a greater throughput over the communication link assuming that the quality of service parameter condition(s) have been met. If the quality of service profile is changed, the procedures may be repeated.

If after a first MCS has been selected, a first request for retransmission of a data unit over the radio link is detected, then a second MCS may be determined and used to retransmit the data unit over the radio communications link. If a second request for retransmission of that data unit is detected, then a third MCS may be used to retransmit that data unit. Moreover, the MCS may be adapted to ensure that an error rate for communications over the radio communications link does not cause the actual delay to exceed a threshold value. In an EGPRS example application, the delay may be a delay determined on a radio link control protocol level or on a link layer protocol level.

### BRIEF DESCRIPTION OF THE DRAWINGS

FIG. 1 illustrates a wireless communications system;

FIG. 2 is a function block diagram illustrating in function block form a base station controller, a radio base station, and a mobile station;

FIG. 3 is a flowchart diagram illustrating example procedures for link adaptation based on a quality of service profile; and

FIG. 4 is a flow chart illustrating example procedures for implementing link adaptation based on a combined quality of service parameter;

### DETAILED DESCRIPTION

The following descriptions set forth specific details, such as particular embodiments, procedures, techniques, etc., for purposes of explanation and not limitation. However, it will be apparent to one skilled in the art that other embodiments may be employed to depart from these specific details. For example, although the following description is facilitated using an example application to a certain type of mobile communication system, the present invention may be used in any wireless communications system. In some instances, detailed descriptions of well-known methods, interfaces, devices, and signalling techniques are omitted so as not to obscure the description with unnecessary detail. Moreover, individual function blocks are shown in some of the figures. Those skilled in the art will appreciate that the functions may be implemented using individual hardware circuits, using software function and conjunction with a suitably programmed digital microprocessor or general purpose computer, using an application specific integrated circuit (ASIC), and/or using one or more digital signal processors (DSPs).

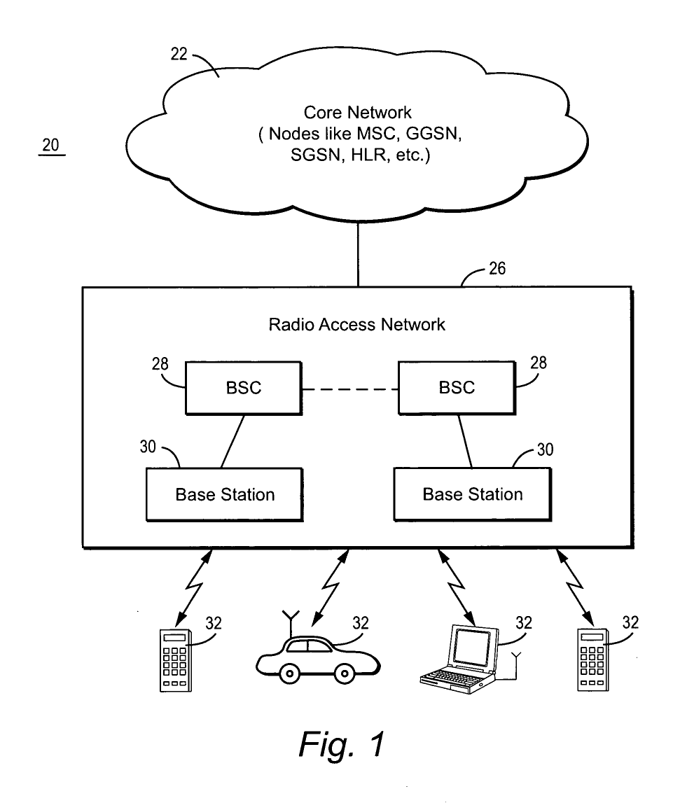

FIG. 1 illustrates a mobile radio communications system 20. A core network, represented as a cloud 22, includes one or more example core network nodes. Examples include as a circuit-switched core network node, like a mobile switching center (MSC), a packet-switched node, such as a gateway GPRS support node (GGSN) or a serving GPRS support node (SGSN), and a database node, such as a home location register (HLR). The core network node(s) 22 is (are) coupled to a radio access network (RAN) 26 which includes one or more base station controller (BSC) nodes 28. Representative BSC nodes 28 are coupled to one or more radio base stations 30. For simplicity, each BSC is shown as coupled to only one base station. Mobile stations 32 communicate over a radio interface with one or more radio base stations 30.

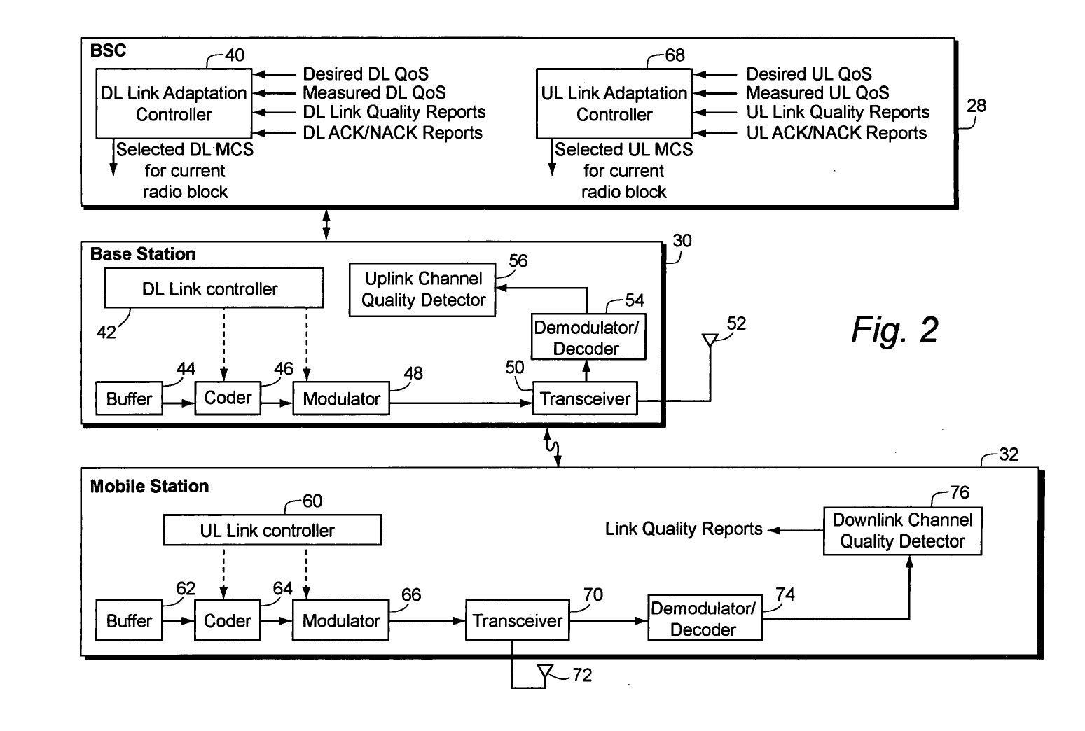

Referring to FIG. 2, the BSC 28 includes, among other things, a downlink link adaptation controller 40, and an uplink (UL) link adaptation controller 68. Although the link adaptation controllers 40 and 68 are shown contained in the BSC 28 in a preferred example embodiment, the link adaptation controllers may independently be located in either the radio base station or in the mobile station if desired. The downlink (DL) link adaptation controller 40 receives a number of inputs including: one or more desired quality of service parameter(s) P1_{desired}, P2_{desired}, . . . Pn_{desired} for the communication link; one or more actually measured or otherwise determined quality of service parameter(s) P1_{actual}, P2_{actual}, . . . Pn_{actual} for the communication link; downlink (DL) quality reports for the communication link; and DL acknowledgement (ACK)/negative acknowledgement (NACK) reports. The uplink (UL) link adaptation controller 68 receives similar inputs but for the uplink as described below.

The desired QoS parameter(s) is(are) determined when the communications link is set up. Non-limiting examples of quality of service parameters include bit rate, (guaranteed, maximum, minimum, etc.), transmission delay (maximum, average, etc.), availability (low down time), connection set up time, bandwidth, packet loss, residual bit error rate, delay jitter, packet size, etc. DL link quality reports and ACK/NACK reports may be provided at regular intervals or at particular “trigger” events by the mobile station 32. The actual DL quality of service parameter value(s) is/are calculated or estimated based on data in the DL link quality reports, DL ACK/NACK reports, data obtained from the base station 30, and/or other internal data available in the BSC 28. Based on the above inputs (or other inputs), the DL link adaptation controller selects a current downlink modulation and coding scheme (MCS) for each radio block to be transmitted. While both a modulation and coding scheme are preferably selected, one or the other may only be selected or adapted if desired. The term MCS is intended to cover both situations.

The base station 30 includes a downlink (DL) link controller 42 that receives commands from the DL link adaptation controller 40 regarding the selected MCS for a current radio block to be transmitted over the downlink. The radio blocks to be transmitted are stored in a buffer 44. Each block output from the buffer 44 is provided to a coder 46, which codes each block in accordance with a particular coding scheme. The coded block is then forwarded to a modulator 48, which modulates the block in accordance with a selected modulation scheme. The downlink controller 42 identifies the selected coding scheme for the coder 46 and the modulation scheme for the modulator 48 in accordance with the link adaptation controller output. The modulated output is provided to a radio transceiver 50, which transmits the modulated signal at RF frequency via antenna 52 over the radio interface to the mobile station 32.

The radio transceiver 50 also detects received signals in the uplink direction from the mobile station, and demodulates/decodes them in a demodulator/decoder block 54. An uplink channel quality detector 56 detects from the received signal an uplink channel quality, which is then provided to the uplink link adaptation controller 68 as an UL link quality report. For example, the channel quality detector 56 may be used to determine a bit error rate (BER), a block error rate (BLER), an estimate of bit error probability (BEP), a block error probability (BLEP), signal strength, interference level, or other channel quality parameter.

The uplink link adaptation controller 68 receives a number of inputs including: one or more desired quality of service parameters P1_{desired} . . . Pn_{desired} for the communication link; one or more actually measured or otherwise determined quality of service parameters P1_{actual} . . . Pn_{actual} for the communication link; UL ACK/NACK reports; and link quality reports for the communication link. The desired QoS parameters are determined when the UL communications link is set up. The UL link quality reports and ACK/NACK reports are, as previously described, received from the uplink channel quality detector 56 in the base station 30. The actual UL quality of service parameter value(s) is/are calculated or estimated based on data in the UL link quality reports, ACK/NACK reports, and/or other internal data available in the BSC 28. Based on the above inputs, the UL link adaptation controller 68 selects a current uplink modulation and coding scheme (MCS) for each radio block to be transmitted in uplink. The information is sent via the base station 30 on the downlink to the mobile station 32. The mobile station 32 uses the signaled MCS until a different MCS is signaled.

The mobile station 32 includes an uplink (UL) link controller 60 that receives commands from the uplink link adaptation controller 68 regarding the selected MCS for a current radio block to be transmitted. The radio blocks to be transmitted are stored in a buffer 62. Each block output from the buffer 62 is provided to a coder 64, which codes each block in accordance with a particular coding scheme. The coded block is then forwarded to a modulator 66, which modulates the block in accordance with a selected modulation scheme. UL link controller 60 identifies the selected coding scheme for the coder 64 and the modulation scheme for the modulator 66 in accordance with the link adaptation controller output. The modulated output is provided to a radio transceiver 70 which transmits the modulated signal at RF frequency via antenna 72 over the radio interface to the base station 30.

Downlink signals from the radio network are also received by the transceiver 70 and demodulated/decoded in a demodulator/decoder 74. The received information is processed by a downlink channel quality detector 76 which assembles a downlink radio link quality report and an ACK/NACK report that are transmitted to the base station and further relayed to the downlink link adaptation controller 40 in the BSC 28. The radio quality report might for example, include a bit error rate (BER), a bit error probability (BEP), a block error rate (BLER), signal strength, interference level, or other parameter.

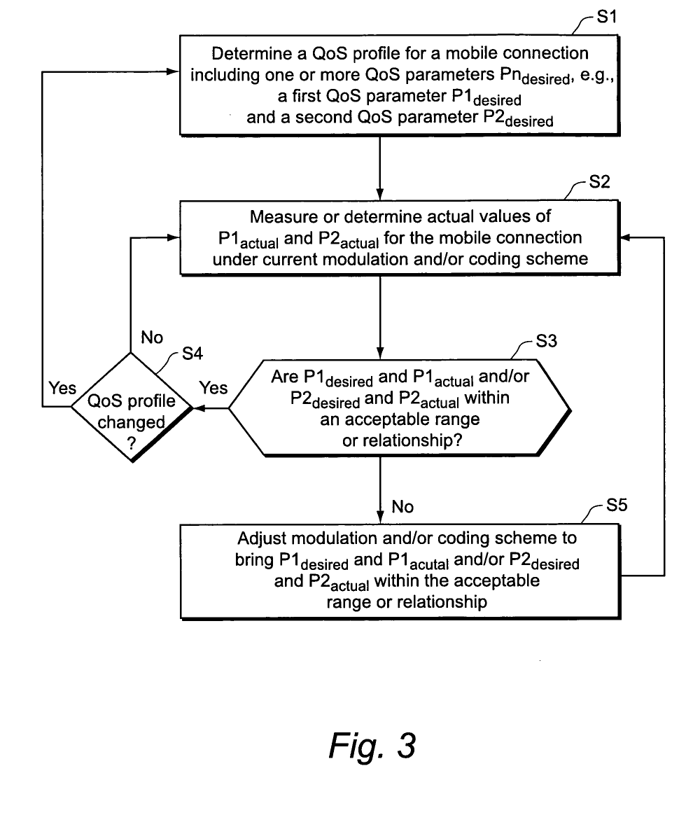

One example set of procedures for implementing a quality of service-based link quality control is now described in conjunction with the flow chart in FIG. 3. A quality of service profile for the mobile connection is determined in step S1. That quality of service profile includes one or more quality of service parameters Pn_{desired}, where n is any positive, non-zero integer. In the following, non-limiting example, n is set to 2: a first quality of service parameter P1_{desired} and a second quality of service parameter P2_{desired}. The actual QoS values P1_{actual} and P2_{actual} are measured or otherwise-determined for the mobile connection under a current MCS (step S2). A decision is made at step S3 whether P1_{desired} and P1_{actual} and/or P2_{desired} and P2_{actual} are within an acceptable range or relationship. If they are, a decision is made at step S4 whether the quality of service profile has changed. If not, control returns to step S2; otherwise, control returns to step S1. If the desired and actual values are not within an acceptable range or relationship, the MCS is adjusted to bring P1_{desired} and P1_{actual} and/or P2_{desired} and P2_{actual} within the acceptable range or relationship (step S5). This closed feedback loop permits reliable, precise, and accurate link quality control that accounts for user-specific QoS requirements.

Consider the non-limiting example where the two quality of service (QoS) parameters for a particular mobile user communication are a maximum transfer delay and a guaranteed bit rate. It will be appreciated that other, fewer, or additional quality of service parameters may be taken into consideration. Assume for purposes of this example only, that link quality control starts off with a least robust, greatest throughput scheme, (which corresponds to MCS-9 in EGPRS).

Based on ACK/NACK reports for each transmitted radio block, the link adaptation controllers can determine whether the maximum transfer delay QoS parameter is being fulfilled. Specifically, the link adaptation controller knows the time when each radio block was originally transmitted and knows the time when a positive acknowledgement (ACK) for that block is received. The difference between those two times can be viewed as a block delay. The block delay is compared to the QoS delay parameter, particularly if the delay parameter is a maximum delay. An average block delay may also be determined using several of such differences and compared against a QoS average delay. The delay may be determined at different protocol levels. In an EGPRS example, delays may be determined at the radio link layer or the logical link layer. A similar delay analysis may be performed at a higher protocol level, e.g., at a packet level, rather than at the radio block level.

If the block or packet is delayed more than the maximum transfer delay established by the user's quality of service profile, a more robust modulation and/or coding scheme can be selected (something less than MCS-9 in the EGPRS example) in order to reduce that actual delay. The MCS can be chosen to be increasingly more robust until the maximum delay transfer requirement is fulfilled, or alternatively, until some percentage, e.g., 95%, of the radio blocks (or packets) are received in less than the maximum transfer delay. This latter approach requires averaging the block/packet delays over a longer time frame. If different MCS's fulfill the quality of service delay requirement, the MCS that produces the highest bit rate over the radio link is preferably selected.

The link throughput can, for example, be calculated as the maximum bit rate of the used MCS multiplied with the fraction of correctly received radio blocks (1-BLER). Another example approach is to calculate the bit rate by examining logical link level data buffers.

Simply adapting the link quality using a link quality report, such as signal strength, interference level, BER, BEP, BLER or BLEP, does not necessarily mean that requested quality of service parameters have been fulfilled. Furthermore, the estimates may be wrong or conditions may have changed by the time the report reaches each link adaptation controller. But by tying link adaptation to one or more actual quality of service parameters compared to one or more desired quality of service parameters in a closed feedback loop, more accurate, more reliable, and more relevant link adaptation is attained.

As mentioned above, one preferable link quality control algorithm attempts to maximize overall link throughput (where the link is shared by multiple users) as well as fulfill user-specific quality of service parameters in the mobile user's quality of service profile. One way to accomplish that is to employ two closed feedback loops. An inner loop is used to select an MCS based on throughput performance over the radio link shared by multiple users. An outer loop is used to control the selection criteria of the inner loop to ensure that individual user quality of service requirements are met.

Assume that a mobile user QoS requirement is delay. The outer loop controls the maximum MCS used in the inner loop, thus ensuring that the coding is robust enough to fulfill the delay requirement. Inputs for the outer feedback loop might include, for example, a user-specific quality of service delay requirement, the actual delay of the transmitted radio blocks for that mobile user (a cause of which may be retransmissions), link quality reports for the radio link such as BLER calculated from, for example, ACK/NACK reports, and the MCS currently used. Based on those inputs, a maximum MCS will be determined to ensure that the delay does not exceed the delay required by the individual mobile user's QoS profile.

One way to adapt the maximum MCS is to decrease the maximum MCS by one step if the largest radio block delay measured since a last MCS change is close to, or over, the QoS requirement. The maximum MCS could then be increased by one step if all block delays are well within the requirements and the BLER is low. The maximum MCS might also be set lower for the second retransmission, ensuring that a more robust MCS is selected for a second retransmission. An even lower maximum MCS for further retransmissions could ensure that an even more robust MCS is selected if further retransmissions are required. When selecting which MCS to use, the inner loop first selects an MCS optimizing the throughput based on the link quality reports. That MCS is then compared to the maximum MCS selected by the outer loop, and if lower, the selected MCS is used. Otherwise, the maximum MCS is used.

Another exemplary illustrative and non-limiting implementation of link quality control based on quality of service parameters is to employ a “combined” quality of service parameter. A “combined” quality of service parameter is a single QoS value generated using two or more QoS parameters from the QoS profile for a mobile station connection. One example using a “combined” quality of service parameter is now described.

The combined measure may be used in both the uplink and/or the downlink independently. Referring to FIG. 2, the link adaptation controller(s) 40 and/or 68 determine(s) one or more combined QoS measures based on the received quality of service parameters. The desired QoS parameters for the link are used to determine a combined desired QoS parameter, and the measured QoS parameters are used to determine a combined measured QoS parameter. The link adaptation controller(s) 40 and/or 68 select(s) the output UL/DL MCS(s) based on the two combined QoS parameters (desired and measured), and possibly also link quality reports and ACK/NACK reports.

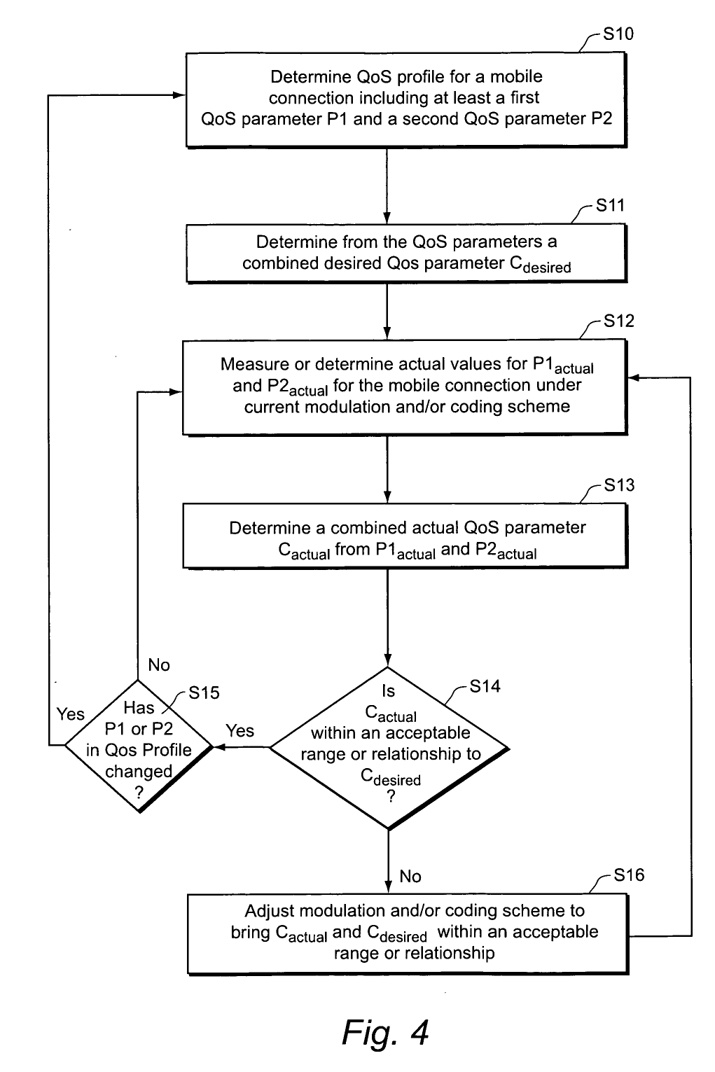

FIG. 4 illustrates in flowchart form example procedures for implementing a link quality control based on a combined quality of service parameter. A quality of service profile is determined for a mobile connection that includes at least a first desired quality of service parameter P1_{desired} and a second desired quality of service parameter P2_{desired} (step S10). A combined desired quality of service parameter C_{desired} is determined from the two (or more) desired quality of service parameters (step S11). Actual values P1_{actual} and P2_{actual} are measured or otherwise determined under the current MCS (step S12). A combined actual quality of service parameter C_{actual} is determined from P1_{actual} and P2_{actual} (step S13). The decision is made whether the combined actual quality of service parameter C_{actual} and combined desired quality of service of parameter C_{desired} are within an acceptable range or relationship (step S14). A decision is made in step S15 whether a quality of service parameter in the quality of service profile has changed. If so, control returns step S10; otherwise, control returns to step S11. Assuming that C_{actual} is not within an acceptable range or relationship with C_{desired}, the MCS is adjusted to bring C_{actual} and C_{desired} within that acceptable range or relationship (step S16).

Consider this non-limiting example of how two quality of service parameters are combined. Of course, other parameter combination approaches may be employed. The quality of service profile for a mobile connection includes a specified bit rate and delay. There is a tradeoff (give and take) between delay and bit rate. For example, higher delay may be tolerated if the bit rate is sufficiently high to compensate for that higher delay. The delay and bit rate are multiplied to provide the combined QoS parameter, which corresponds to a number of bits to be sent for this communication per unit time. Assuming that the transmitted data blocks contain some type of time stamp and known number of bits, the combined actual QoS parameter can be determined and fed back to the link quality controller. The link quality controller then compares the combined desired parameter with the combined actual parameter. Based on that comparison, the controller controls selection of the MCS as a function of how well the requested quality of service is being provided. Combining quality of service parameters allows a single measure to be used in a single feedback loop control for selecting a best MCS. Since the actual parameter values are measured, and the MCS is regulated in a way that brings the measured quality of service parameter values towards their desired values, the requested quality of service is maintained independently of the specific service or its characteristics.

An alternative combined measure could be the size of a leaky bucket—a variable that is decreased at a regular rate and increased when radio blocks have been correctly received. The leaky bucket could be initiated to the value of the required bit rate multiplied with the required delay. Bits from the bucket are then removed at a rate corresponding to the required bit rate. At the same time, the bucket is continuously filled with the number of correctly received bits. The leaky bucket is then a measure of the margin for these QoS requirements. If the leaky bucket level decreases below zero during the communication session, then the QoS requirements are not met.

Using a combined QoS parameter measures simplifies the design of the link quality control algorithm and permits a simple and effective feedback control. Instead of using two feedback loops or considering two parameters separately, the measured combined value is moved towards the desired combined value in a single feedback loop.

While practical and preferred embodiments have been described, it is to be understood that the invention is not to be limited to any disclosed embodiment, but on the contrary, is intended to cover various modifications and equivalent arrangements included within the scope of the appended claims.

1. A method related to a communication between a radio network and a wireless subscriber unit over a radio link, comprising:
determining a quality of service (QoS) profile for the communication with the subscriber unit over the radio link that includes one or more desired QoS parameters with at least a first desired QoS parameter;
determining for the communication with the subscriber unit a first actual QoS parameter; and
determining whether the first desired QoS parameter and the first actual QoS parameter are within an acceptable range or an acceptable relationship; and
selecting or adjusting a modulation and coding scheme (MCS) for transmitting information over the radio link based on whether the first desired QoS parameter and the first actual QoS parameter are within an acceptable range or an acceptable relationship.

2. The method in claim 1, further comprising:
combining the first desired QoS and a second desired QoS parameters into a combined desired QoS parameter, and
combining the first actual QoS perameter and a second actual QoS parameters into a combined actual QoS parameter,
wherein the selecting or adjusting selects or adjusts the MCS based on whether the combined desired QoS parameter and the combined actual QoS parameter are within an acceptable range or an acceptable relationship.

3. The method in claim 2, further comprising:
selecting or adjusting the modulation and coding scheme (MCS) for transmitting information over the radio communications link based on whether the first desired QoS parameter and the first actual QoS parameter are within an acceptable range or an acceptable relationship and whether the second desired QoS parameter and the second actual QoS parameter are within an acceptable range or an acceptable relationship.

4. The method in claim 2, wherein the first QoS parameter is bit rate and the second QoS parameter is delay.

5. The method in claim 1, further comprising:
determining the MCS to provide a greatest throughput over the radio link shared by multiple wireless subscriber units where the first actual QoS parameter and the first desired QoS parameter are within an acceptable range or an acceptable relationship.

6. The method in claim 1, further comprising:
detecting a change in the QoS profile, and
repeating the steps in claim 1.

7. The method in claim 1, wherein the selected or adjusted MCS is a first MCS, the method further comprising:
detecting a first request for retransmission of a data unit, and
determining a second MCS for retransmitting the data unit over the radio communications link.

8. The method in claim 7, further comprising:
detecting a second request for retransmission of the data unit, and
determining a third MCS for retransmitting the data unit over the radio communications link.

9. The method in claim 1, wherein the first desired QoS parameter is delay, the method further comprising:
adapting the MCS to ensure that an error rate for communications over the radio communications link does not cause the actual delay to exceed a threshold value.

10. The method in claim 9, wherein the delay is a delay on a radio link control protocol level.

11. The method in claim 9, wherein the delay is a delay on a logical link layer control protocol level.

12. The method in claim 9, wherein the MCS is adapted incrementally.

13. The method in claim 1, wherein the MCS is selected or adjusted for transmitting information over the radio link from the radio network to the wireless subscriber unit.

14. The method in claim 1, wherein the MCS is selected or adjusted for transmitting information over the radio link from the wireless subscriber unit to the radio network.

15. A method related to a communication between a radio network and a wireless subscriber unit over a radio link, comprising:
determining a quality of service (QoS) profile for the communication with the subscriber unit over the radio link that includes a first desired QoS parameter and a second desired QoS parameter;
determining a combined desired QoS parameter using the first desired QoS parameter and the second desired QoS parameter;
determining for the communication with the subscriber unit a first actual QoS parameter and a second actual QoS parameter;
determining a combined actual QoS parameter using the first actual QoS parameter and the second actual QoS parameter; and
determining whether the combined desired QoS parameter and the combined actual QoS parameter are within an acceptable range or an acceptable relationship; and
selecting or adjusting a modulation and coding scheme (MCS) for transmitting information over the radio link based on whether the combined desired QoS parameter and the combined actual QoS parameter are within an acceptable range or an acceptable relationship.

16. The method in claim 15, wherein the first and second QoS parameters correspond to a guaranteed bit rate and a maximum transfer delay.

17. The method in claim 15, further comprising:
determining the MCS to provide a greatest throughput over the radio link shared by multiple wireless subscriber units assuming the combined desired QoS parameter and the combined actual QoS parameter are within an acceptable range or an acceptable relationship.

18. The method in claim 15, further comprising:
detecting a change in the QoS profile, and
repeating the steps in claim 15.

19. The method in claim 15, wherein the MCS is selected or adjusted for transmitting information over the radio link from the radio network to the wireless subscriber unit.

20. The method in claim 15, wherein the MCS is selected or adjusted for transmitting information over the radio link from the wireless subscriber unit to the radio network.

21. Apparatus for use in a communication between a radio network and a wireless subscriber unit over a radio link, comprising:
means for determining a quality of service (QoS) profile for the communication that includes a first actual QoS parameter and a second desired QoS parameter;
means for determining for the communication a first actual QoS parameter and a second actual QoS parameter; and
means for determining whether the first desired QoS parameter and the first actual QoS parameter are within an acceptable range or an acceptable relationship; means for determining whether the second desired QoS parameter and the second actual QoS parameter are within an acceptable range or an acceptable relationship; and
means for selecting or adjusting a modulation and coding scheme (MCS) for transmitting information over the radio link based on whether the first desired QoS parameter and the first actual QoS parameter are within an acceptable range or an acceptable relationship or whether the second actual QoS parameter and the second actual QoS parameter are within an acceptable range or an acceptable relationship.

22. The apparatus in claim 21, further comprising:
means for combining the first and second desired QoS parameters into a combined desired QoS parameter, and
means for combining the first and second actual QoS parameters into a combined actual QoS parameters,
wherein the means for selecting or adjusting selects or adjusts the MCS based on whether the combined desired QoS parameter and the combined actual QoS parameter are within an acceptable range or an acceptable relationship.

23. The apparatus in claim 22, wherein the first QoS parameter is a guaranteed bit rate and the second QoS parameter is maximum transfer delay.

24. The apparatus in claim 21, further comprising:
means for determining the MCS to provide a greatest throughput over the radio communications link where the first and second actual QoS parameters and the first and second desired QoS parameters, respectively, are within an acceptable range or an acceptable relationship.

25. The apparatus in claim 21, wherein the MCS is selected or adjusted for transmitting information over the radio link from the radio network to the wireless subscriber unit.

26. The apparatus in claim 21, wherein the MCS is selected or adjusted for transmitting information over the radio link from the wireless subscriber unit to the radio network.

27. A mobile station for use in a communication between a radio network and the mobile station over a radio link, comprising:
a coder for coding information to be transmitted;
a modulator for modulating the coded information;
a transceiver for transmitting the modulated information;
a controller for determining for the communication a first desired QoS parameter and a second desired QoS parameter; and
a QoS detector for determining for the communication a first actual QoS parameter and a second actual QoS parameter,
wherein the controller is configured to:
determine whether the first desired QoS parameter and the first actual QoS parameter are within an acceptable range or an acceptable relationship;
determine whether the second desired QoS parameter and the second actual QoS parameter are within an acceptable range or an acceptable relationship; and
select or adjust a modulation scheme implemented in the modulator or a coding scheme implemented in the coder for transmitting information over the radio link based on whether the first desired QoS parameter and
the first actual QoS parameter are within an acceptable range or an
acceptable relationship or whether the second desired QoS parameter and the second actual QoS parameter are within an acceptable range or an acceptable relationship.

28. The mobile station in claim 27, further comprising:
a combiner for combining the first and second desired QoS parameters into a combined desired QoS parameter and for combining the first and second actual QoS parameters into a combined actual QoS parameter,
wherein the controller is configured to select or adjust the modulator or the coder based on whether the combined desired QoS parameter and the combined actual QoS parameter are within an acceptable range or an acceptable relationship.

29. The mobile station in claim 28, wherein the first QoS parameter is bit rate and the second QoS parameter is transmission delay.

30. The mobile station in claim 27, wherein the controller is configured to determine the MCS to provide a greatest throughput over the radio communications link where the first and second actual QoS parameters and the first and second desired QoS parameters, respectively, are within an acceptable range or an acceptable relationship.

31. Radio network apparatus for use in a communication between a radio network and the mobile station over a radio link, comprising:
a coder for coding information to be transmitted;
a modulator for modulating the coded information;
a transceiver for transmitting the modulated information;
a QoS detector for determining for the communication a first actual QoS parameter and a second actual QoS parameter;
a first controller for determining for the communication a first desired QoS parameter and a second desired QoS parameter, determining whether the first desired QoS parameter and the first actual QoS parameter are within an acceptable range or an acceptable relationship, and determining whether the second desired QoS parameter and the second actual QoS parameter are within an acceptable range or an acceptable relationship; and
a second controller for selecting or adjusting a modulation scheme implemented in the modulator or a coding scheme implemented in the coder for transmitting information over the radio link based on whether the first desired QoS parameter and the first actual QoS parameter are within an acceptable range or an acceptable relationship or whether the second desired QoS parameter and the second actual QoS parameter are within an acceptable range or an acceptable relationship.

32. The radio network apparatus in claim 31, wherein the first and second QoS parameters correspond to bit rate and transmission delay.

33. The radio network apparatus in claim 31, further comprising:
a combiner for combining the first and second desired QoS parameters into a combined desired QoS parameter and for combining the first and second actual QoS parameters into a combined actual QoS parameter,
wherein the first controller or second controller is configured to select or adjust the modulator or the coder based on whether the combined desired QoS parameter and the combined actual QoS parameter are within an acceptable range or an acceptable relationship.

34. The radio network apparatus in claim 31, wherein the first controller is configured to determine the MCS to provide a greatest throughput over the radio communications link where the first and second actual QoS parameters the first and second desired QoS parameters, respectively, are within an acceptable range or an acceptable relationship.

35. The radio network apparatus in claim 34, wherein the decision whether the first desired QoS parameter and the first actual QoS parameter are within an acceptable range or an acceptable relationship is made in the radio network.

36. The radio network apparatus in claim 34, wherein the decision whether the first desired QoS parameter and the first actual QoS parameter are within an acceptable range or an acceptable relationship is made in the mobile station.

37. The radio network apparatus in claim 34, further comprising:
a combiner for combining the first actual QoS parameter and a second actual QoS parameter into a combined actual QoS parameter,
wherein the controller is configured to select or adjust the modulator or the coder based on whether the combined desired QoS parameter and the combined actual QoS parameter are within an acceptable range or an acceptable relationship.

38. The radio network apparatus in claim 37, wherein the first QoS parameter is bit rate and the second QoS parameter is transmission delay.

39. The radio network apparatus in claim 34, wherein the MCS is selected or adjusted to provide a greatest throughput over the radio communications link when the first actual QoS parameter and the first desired QoS parameter are within an acceptable range or an acceptable relationship.

40. The radio network apparatus in claim 34, wherein the radio network apparatus is implemented partially in a radio base station and partially in a radio base station controller.

41. The radio network apparatus in claim 34, wherein the radio network apparatus is implemented in a radio base station.

42. Radio network apparatus for use in a communication between a radio network and the mobile station over a radio link, comprising:
a coder for coding information to be transmitted;
a modulator for modulating the coded information;
a transceiver for transmitting the modulated information;
a QoS detector for determining for the communication a first actual QoS parameter;
a first controller for determining for the communication a first desired QoS parameter and whether the first desired QoS parameter and the first actual QoS parameter are within an acceptable range or an acceptable relationship; and
a second controller for selecting or adjusting a modulation scheme implemented in the modulator or a coding scheme implemented in the coder for transmitting information over the radio link based on whether the first desired QoS parameter and the first actual QoS parameter are within an acceptable range or an acceptable relationship.

43. The radio network apparatus in claim 42, wherein
the QoS detector is configured to determine a second actual QoS parameter, the first controller is configured to determine for the communication a second desired QoS parameter and to determine whether the second desired QoS parameter and the second actual QoS parameter are within an acceptable range or an acceptable relationship, and
the second controller is configured to further select or adjust the modulation scheme implemented in the modulator or the coding scheme implemented in the coder for transmitting information over the radio link based on whether the second desired QoS parameter and the second actual QoS parameter are within an acceptable range or an acceptable relationship

44. The radio network apparatus in claim 43, wherein the first and second QoS parameters correspond to bit rate and transmission delay.

45. The radio network apparatus in claim 42, wherein the QoS detector is configured to determine a second actual QoS parameter, the first controller is configured to determine a second desired QoS parameter, further comprising:
a combiner for combining the first and second desired QoS parameters into a combined desired QoS parameter and for combining the first and second actual QoS parameters into a combined actual QoS parameter,
wherein the first controller or second controller is configured to select or adjust the modulator or the coder based on whether the combined desired QoS parameter and the combined actual QoS parameter are within an acceptable range or an acceptable relationship.

46. The radio network apparatus in claim 42, wherein the first controller is configured to determine the MCS to provide a greatest throughput over the radio communications link where the first actual QoS parameter and the first desired QoS parameter are within an acceptable range or an acceptable relationship.

47. The radio network apparatus in claim 42, wherein the coder, modulator, transceiver, and quality detector are in a radio base station and the first and second controllers are in a radio network controller coupled to the radio base station.

48. The radio network apparatus in claim 42, wherein the coder, modulator, transceiver, quality detector, and second controller are in a radio base station and the first controller is in a radio network controller coupled to the radio base station.

49. The radio network apparatus in claim 42, wherein the coder, modulator, transceiver, quality detector, the first controller, and the second controller are in a radio base station.
